(19) United States
(12) Patent Application Publication
(10) Pub. No.: US 2010/0088208 A1
(43) Pub. Date: Apr. 8, 2010

(54) METHOD AND SYSTEM FOR FACILITATING SHIPPING

(75) Inventors: Ashish Saxena, Singapore (SG); Supriya Rao Patwardhan, Kuala Lumpur (MY)

Correspondence Address: International IP Law Group, P.O. BOX 691927, HOUSTON, TX, 77269-1927, US

(73) Assignee: Deutsche Post AG, Bonn (DE)

(21) Appl. No.: 12/597,251

(22) PCT Filed: Apr. 27, 2007
(86) PCT No.: PCT/EP07/03754

§ 371 Date: Oct. 23, 2009

(51) Int. Cl. G06Q 50/00; G06Q 30/00; G06F 15/16

(52) U.S. Cl. 705/34; 705/330; 709/206

(57) ABSTRACT

There is provided a system and method for facilitating shipping. An exemplary method comprises providing a shipping bill form at a front-end of a computer system. The exemplary method also comprises enabling a user at the front-end to fill in shipping information associated with the shipping bill form and to send an email message or an instant message incorporating the filled in shipping bill form to a back-end of the computer system.

### CROSS REFERENCE TO RELATED APPLICATION

Pursuant to 35 U.S.C. §371, this application is the United States National Stage Application of International Patent Application No. PCT/EP2007/003754, filed on Apr. 27, 2007, the contents of which are incorporated by reference as if set forth in their entirety herein.

### FIELD OF THE INVENTION

An exemplary embodiment of the present invention relates generally to logistics systems and methods. In particular, an exemplary embodiment of the present invention relates to a method and a computer system for facilitating the shipping of goods.

### BACKGROUND

Logistics systems manage the shipments of goods. They comprise a variety of modules integrated with each other to perform various functionalities. For example, they may comprise a purchasing module evaluating proposals for respective shipments of goods and awarding contracts for the shipments. There may be optimization modules analyzing the proposals and informing the purchasing module if an opportunity exists for at least some of the shipments to be consolidated, in which case at least one contract awarded by the purchasing module is for a consolidated group of the shipments. Administration modules may maintain information relating to the status of proposals received and contracts awarded by the purchasing module. A scheduling module may schedule shipments according to the awarded contracts. On the basis of a shipment management module it is also possible to track the status of shipments awarded by the purchasing module and scheduled by said scheduling module. A financial module may authorize payments according to the status of shipments tracked by the shipment management module which are for example passed between first and second asynchronous clock domains.

A method and a system for updating status information about shipments via email are known from U.S. Pat. No. 6,047,264. This document discloses a method for automatically updating the status of a user's orders and shipments via email without using a human attendant by creating and sending email messages.

A web-based electronic shipment system is described in U.S. Pat. No. 6,220,509. There is disclosed a parcel trace system which provides a browser design adapted for one shipping provider and a plurality of clients and another browser design adapted for one client and a plurality of shipping providers.

The shipping of mail and parcel items can typically be described in terms of three primary transport legs. In the first leg, a shipping item, e.g. an envelope, a package, etc., is taken from an initial senders address to a local collection centre of a shipping service provider. In the second leg, the item is transported from the local collection centre to a delivery centre. In the third leg, the item is transported from the delivery centre to its final destination address.

In general, it is possible that multiple shipping service providers may be employed over the three primary transport legs set forth above. For example, a local courier might provide transportation of a package from a business to a national or regional carrier's drop location, thus handling the first leg. The national or regional carrier might then provide service over the second leg, transporting the package from the drop location, possibly through one or more intermediate hubs, to a delivery centre near the destination address. A third shipping entity may then provide delivery over the last leg.

It is also possible that a single shipping service provider may provide service over two or more legs. For example, a local courier might provide service over the first leg by transporting a package from a business or residence to a local post office, where another shipping service provider provides service over the second and third legs. There are shipping entities that provide door to door service on their own.

Some shipping service providers have an established infrastructure for carrying out the second and third legs of the shipping process. These companies are well equipped for sorting, routing and transporting mail and parcel items once the items are received at a collection warehouse.

The first leg, however, requires that the sender either brings the shipment to the collection centre or makes arrangements for a shipping service provider to pick up the item from the initial address. For example, until recently, in order to use the shipping services, one had either to wait for the postman to come on his regularly scheduled delivery rounds, or carry the shipment to a post office and wait in line to deliver the shipment. To address this issue, some shipping service providers have specialized in picking up shipments from users and transporting them to the addressee's local post office. The shipping service providers thereby provide shipment pick-up from the sender's premises.

In addition to providing pick-up services, shipping service providers are looking for new technology to improve consumer access to shipping services. In these cases, the user may navigate to a web page to request limited pick-up services.

The pick-up process, as it is currently conducted, is cumbersome and costly to the user and the shipper. Unless there are large numbers of packages to be collected from each pick-up point, the cost of picking up shipments from a single user is relatively high for a shipping service provider. Also, for a service provider to optimize its pick-up stops, the user has to follow scheduling restrictions. For example, in order to use pick-up services, the user has to schedule a pick-up time through a web site over the Internet for each pick-up.

These solutions for helping users ship mail and parcels still put a burden on the user, e.g. by necessitating time-consuming user interaction, creating time restrictions and/or demanding higher costs. Therefore, there is a need for an efficient solution to facilitate the process of shipping for the user.

### SUMMARY OF THE INVENTION

In the following description, shipping refers to the transport of any mail or goods using any available transportation method. Shipping typically involves one or more legs of transportation from an origin location to a destination. Terms referring to mail, package, parcel or shipment are interchangeably used to refer to any and all shipped items.

The disclosure may interchangeably refer to a courier, a pick-up service provider and a shipper as a person, a group of persons or a company that carries out the task of transporting a shipment from an initial location to a different location.

A method for facilitating shipping according to an exemplary embodiment of the present invention comprises the following steps:
providing a shipping bill form at a front-end of a computer system;
enabling a user at the front-end to fill in shipping information associated with said shipping bill form and to send an email message or an instant message incorporating said filled in shipping bill form to a back-end of said computer system.

A method according to an exemplary embodiment of the present invention does not depend on a system and environment of the user or on mobile or fixed devices. The method is not selective as it can work on any device capable of sending and receiving email messages or instant messages using for example any of the email clients like MS Outlook, Lotus Notes or the like. There is a dependency on the email client then and not on the hardware.

Accurate and timely shipment information is vital to processing the shipments speedily. an exemplary embodiment of the present invention may allow users to easily send their shipment information to a shipper so that the shipper can receive shipment information for example via email. This opens up a new segment for a small and medium category of users who are otherwise difficult to attract with any current eCommerce tools. Email is a universal and widely used mode of communication today and none of the known shippers provide this functionality as yet, hence the tool fits an immediate need and gap in the service offering.

Any user with the ability to access his or her email or instant messaging account on any device will be able to use the services. In principal it may be possible to carry out an exemplary embodiment of the present invention with other messaging systems as well, e.g. SMS (short message service) or MMS (multimedia messaging service).

A method according to an exemplary embodiment of the present invention typically includes generating a shipping bill. The shipping bill is printed on a local printer and affixed to the shipment. The shipping bill typically contains shipping information, such as the source and destination addresses, the size and/or weight of the package.

Once the shipping information data is securely transmitted to the back-end, the back-end of the computer system may analyze the data for any potential errors, and validate the data. Upon validation of the user's shipping information, the system may further present a user agreement comprising a set of terms and rules, e.g. statutory and/or contractual, that the user must acknowledge and accept in order to activate service. The user reviews the agreement and provides an input that indicates the user's consent to the terms.

A shipping bill generation module comprised by the computer system may include tools for generating shipping bill forms for certain types of shipments, including custom shipment modes that may not otherwise be provided by shipping service providers.

An exemplary embodiment of the method comprises automatically sending an email draft message or an instant draft message, incorporating said filled in shipping bill form to be sent by the user for convenience.

In another exemplary embodiment, said shipping bill form comprises a way bill form, an air way bill form, a sea way bill form or an express way bill form.

A focus is on the shipment process via email with the ability to generate and send transportation documents like air way bills and/or sea way bills for air and/or ocean freight to the user.

According to a further exemplary embodiment of the method, said shipping bill form comprises an invoice.

A financial module may authorize payments according to the status of shipments tracked by the shipment management module which are, for example, passed between first and second asynchronous clock domains.

An exemplary embodiment of the present invention further comprises to provide payment functionality to users to enable them to pay by Cash, Credit Card, and Debit Card etc. In such a scenario, once a user/user receives an email Ship template and then he also has the ability upfront to enter his/her credit card details etc in the template itself and once the provider receives the data, the provider can validate it accordingly and provide a quotation or an appropriate response back to the user based on the data inputted by the user.

An exemplary embodiment of the present invention also comprises a payment method by cash, whereby once the courier comes to pick up the package then he can also receive cash directly from the users, based on the quotation generated using email Ship.

### BRIEF DESCRIPTION OF THE DRAWINGS

FIG. 1 is a block diagram showing a computer system according to an exemplary embodiment of the present invention;

FIG. 2 is a flowchart illustrating a process of classifying a user request according to an exemplary embodiment of the present invention;

FIG. 3 is a flowchart illustrating a continuation of the process in FIG. 2 according to an exemplary embodiment of the present invention;

FIG. 4 is a flowchart illustrating the label “AP GAS” in the flowchart of FIG. 3 in further detail;

FIG. 5 is a flowchart illustrating the labels “E1” and “E2” in the flowchart of FIG. 3 in further detail;

FIG. 6 is a block diagram of a system according to an exemplary embodiment of the invention;

FIG. 7 is a diagram of a Shipment Air Waybill as provided in PDF format according to an exemplary embodiment of the present invention,

FIG. 8 is a diagram of a Commercial Invoice form to be filled in for dutiable shipments according to an exemplary embodiment of the present invention; and

FIG. 9 is a diagram of a pick-up request form as provided in PDF format according to an exemplary embodiment of the present invention.

### DETAILED DESCRIPTION OF SPECIFIC EMBODIMENTS

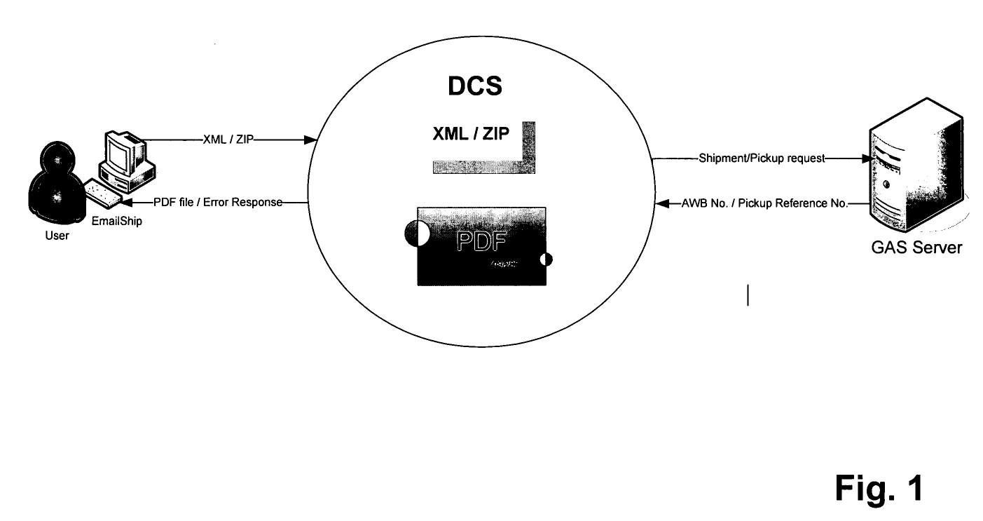

FIG. 1 shows a diagram illustrating an example of a computer system according to an exemplary embodiment of the present invention with a user at a front-end displaying a PDF format via email. Data is transmitted in a XML/ZIP format to a back-end comprising a server, namely a General Application Server (GAS). The GAS processes shipment and pick-up requests from the user.

Preferably a dynamic channel selection is implemented in order to increase flexibility.

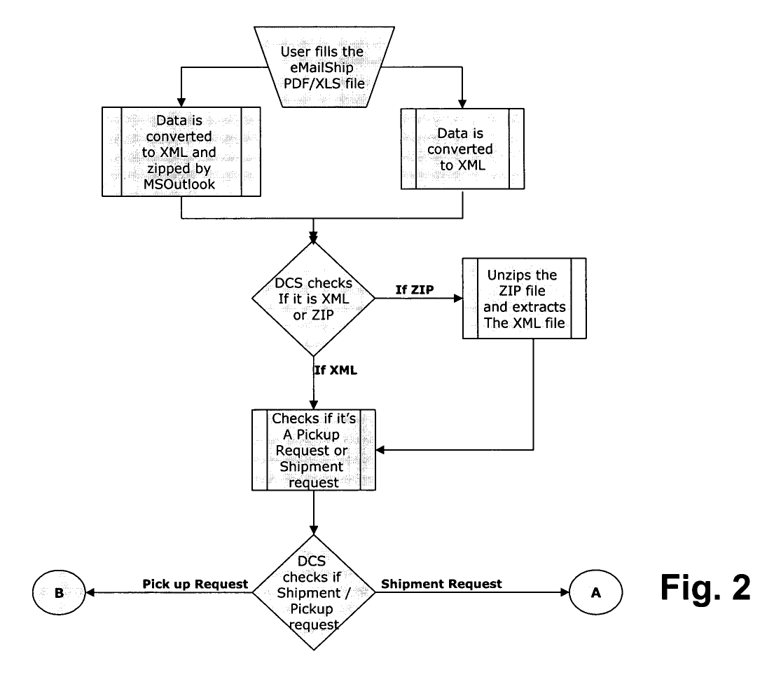

FIG. 2 shows a flowchart illustrating an example of a process of classifying a user request according to its data format and according to the request being a shipping request or a pick-up request.

A user fills the emailship file.

The data is converted to an appropriate data format, for example to XML and optionally zipped by an email program as for example MS-Outlook.

The dynamic channel selection—dynamic channel selector—checks if the format is XML or a zipped format. If the format is zipped the Zip file is unzipped and the contained XML file is extracted.

If the format is already XML it is checked if the message is a pick-up request or a shipment request.

Afterwards the dynamic channel selection checks if it is a shipment request or a pick-up request and initiates the further processes.

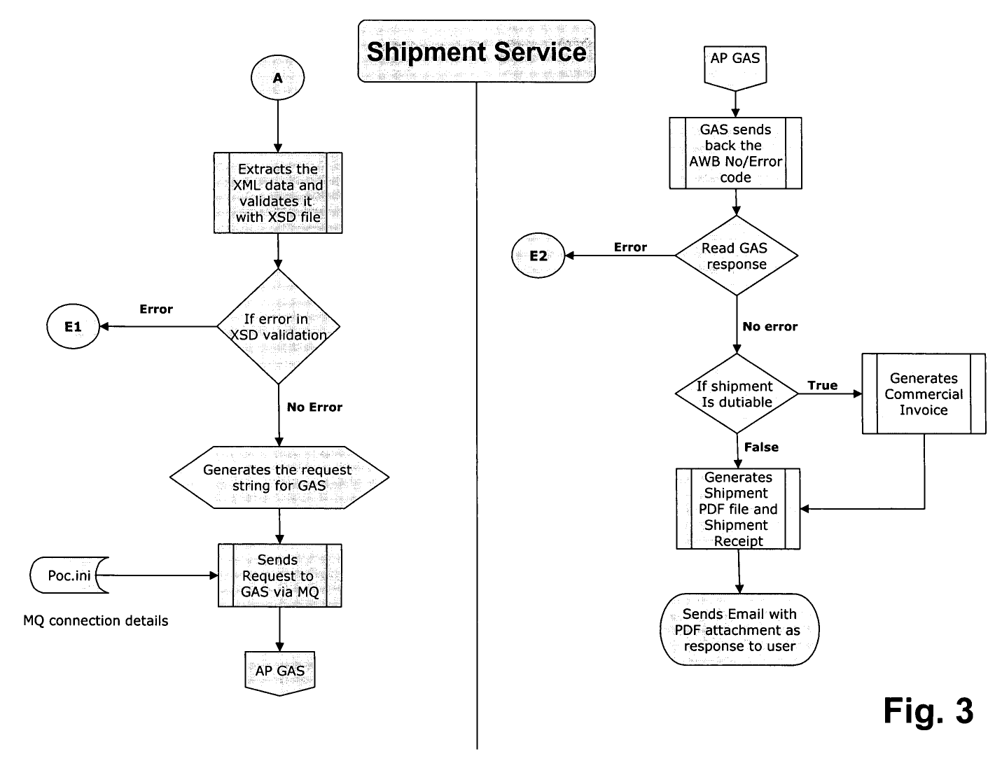

FIG. 3 shows a flowchart illustrating a continuation of the process in FIG. 2 in case that the user request is a shipment request. The GAS in this example is primarily a set of libraries written in C++.

The XML data are extracted and validated with an appropriate file especially XSD file.

If an error occurs an error handling procedure is started.

If no error occurs, the shipment service generates the request string for the generic application server (GAS) and sends the request to the GAS via message queue MQ.

The generic application sends back the air way bill AWB with an appropriate message code—no error code/error code.

If an error code is received, an error correction procedure E2 is started.

If no error code is received, it is checked if the shipment is dutiable.

If the shipment is dutiable, a commercial invoice is generated.

If the shipment is not dutiable, a shipment PDF file and a shipment receipt are generated.

Afterwards, an email is sent to the user with an appropriate attachment, for example, in PDF format, as a response to the user.

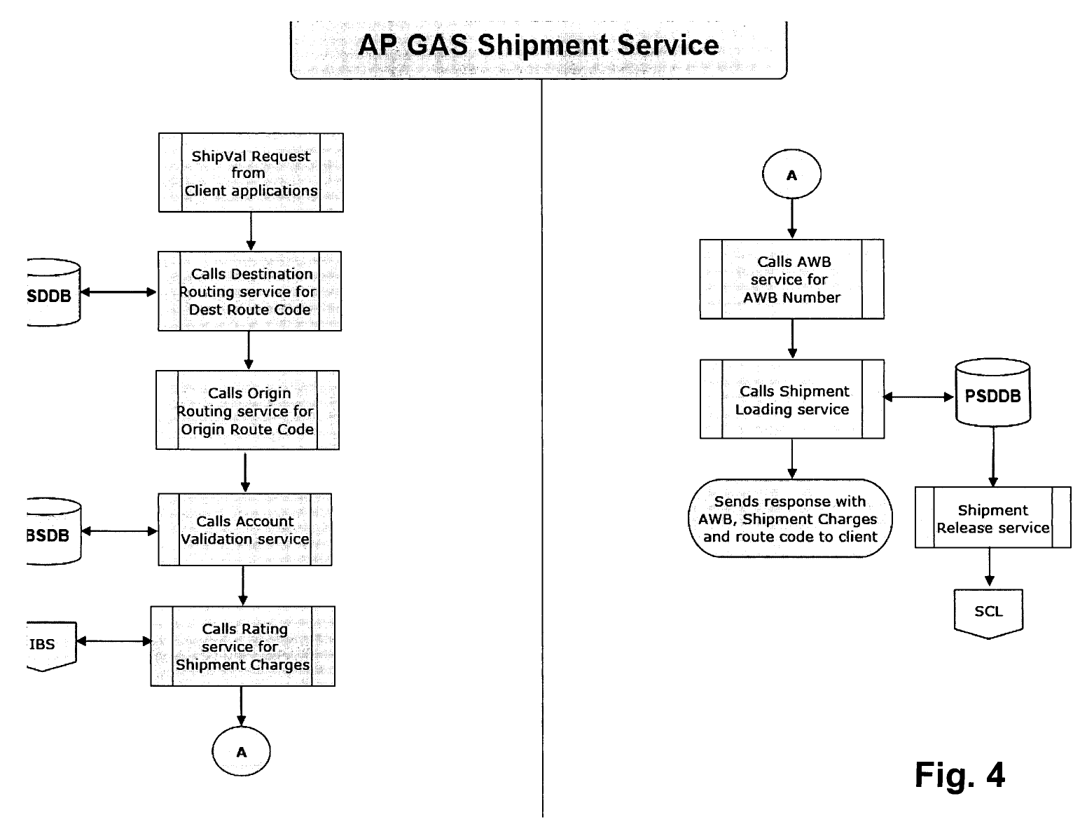

FIG. 4 shows a flowchart illustrating the label “AP GAS” in the flowchart of FIG. 3 in further detail.

A shipment validation request is received from a client application.

A database ESDDB calls destination routing service for destination route code.

Further routing service for an origin route code are called.

A further database IBSDB calls account and validation service.

An intelligent business service IBS calls rating service for shipment charges.

Afterwards an air way bill AWB service form generating an AWB number is activated.

A further database PSDDB calls for shipment loading service. Afterwards, a response is send to the user with an air way bill AWB, shipment charges and route codes.

The database PSDDB communicates with a shipment release service in a structured control language SCL.

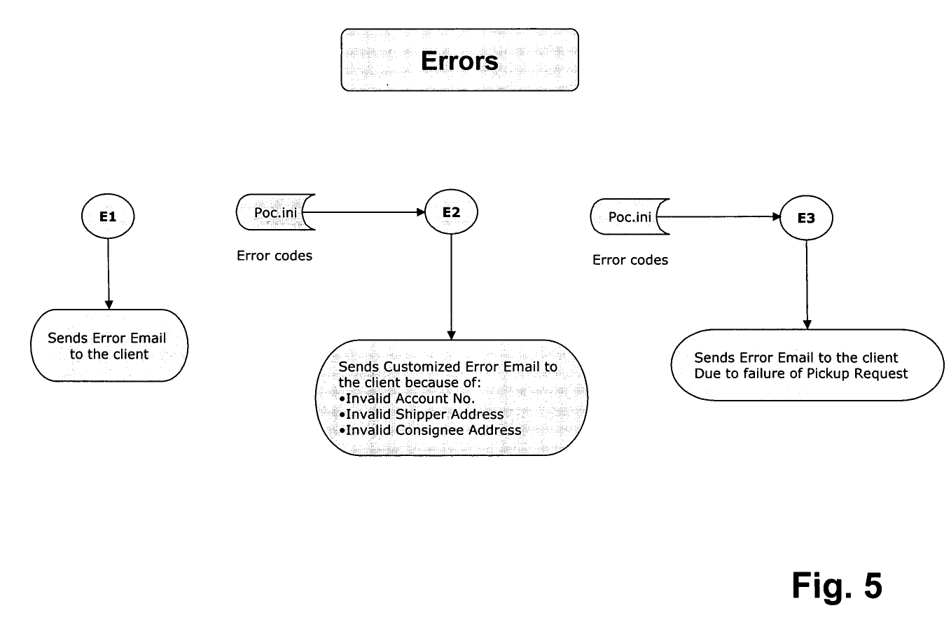

FIG. 5 shows a flowchart illustrating the labels “E1” and “E2” in more detail. “E1” and “E2” represent errors in the process of FIG. 3. “E3” represents a further error due to a failure in a pick-up request, which is not comprised by the process in FIG. 3.

The error procedure E1 includes sending an error email to the user.

According to the error procedure E2, after receipt of an error code Poc.ini, a customized error email is send to the user. Reasons for this are for example an invalid account number, an invalid shipper address or an invalid consignee address.

The error method E3 is also activated by a receipt of an error code Poc.ini. In this case, an error email is sent to the user due to a failure of a pickup request.

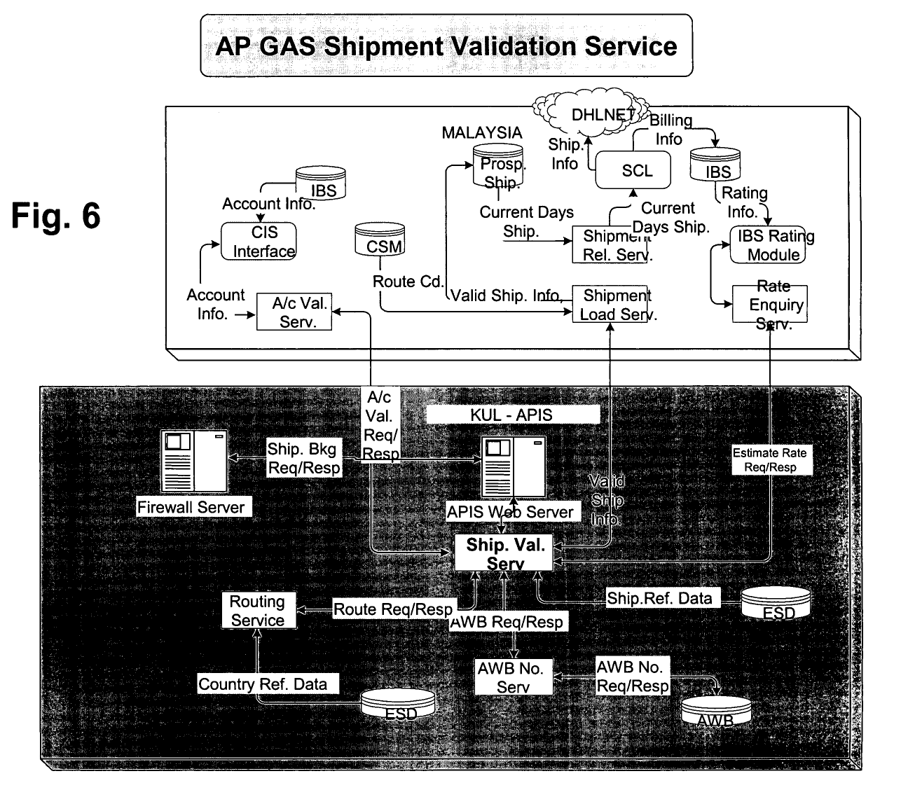

FIG. 6 shows a schematic diagram illustrating a system in which an application is incorporated into an exemplary embodiment of the invention. In the exemplary embodiment shown in FIG. 6, the shipper is DHL in Malaysia and the users are authorized employees and passengers at the airport in Kuala Lumpur.

DHL is a preferred provider of a logistics system. The logistics system includes a handling of objects and preferably additional functionality as for example accounting services.

FIG. 6 shows a preferred embodiment of a shipment validation service according to an exemplary embodiment of the present invention.

The example set forth in FIG. 6 shows that the shipment validation can comprise a different type of data and information, for example account information, billing information, shipment information, routing service and shipment reference data.

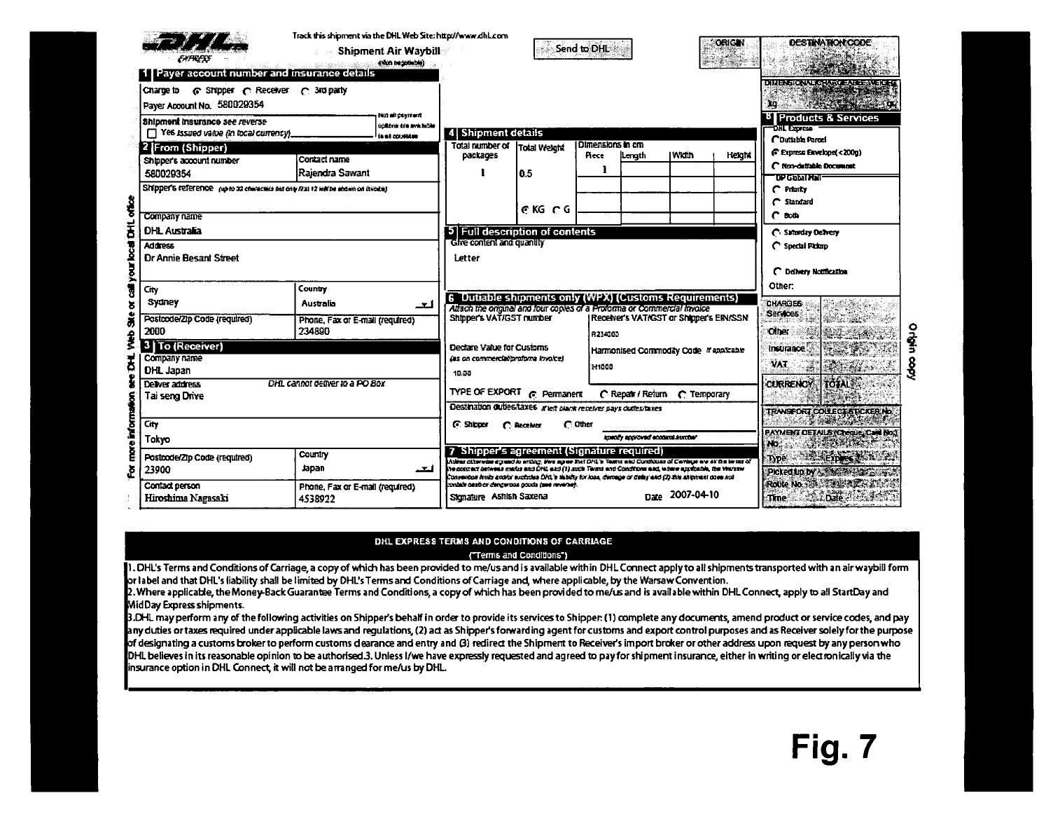

FIG. 7 shows an example of a Shipment Air Waybill as provided in PDF format, filled in by a user at a front-end of the computer system and ready for being printed out.

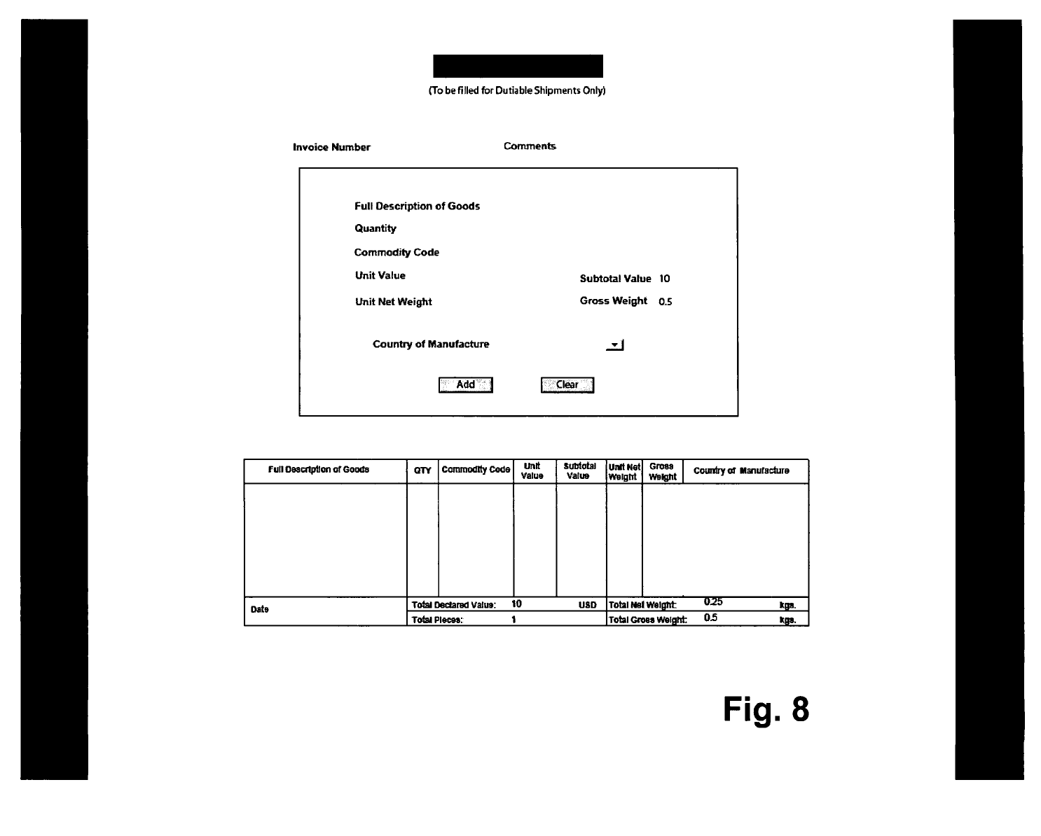

FIG. 8 is an example of a Commercial Invoice form to be filled in for dutiable shipments as provided in PDF format.

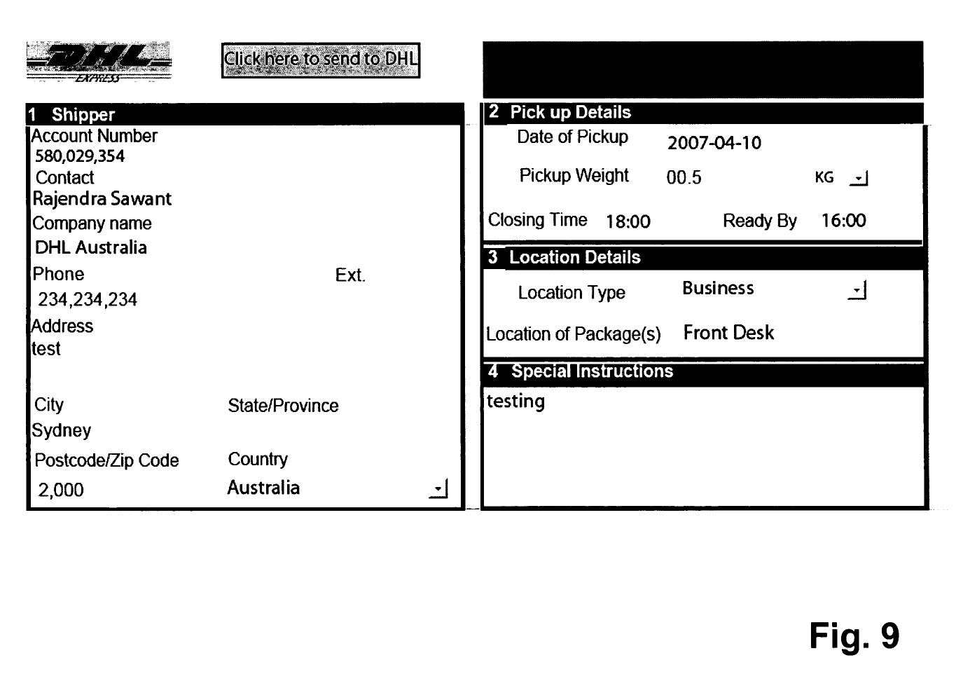

FIG. 9 is an example of a pick-up request form as provided in PDF format.

According to an exemplary embodiment of the present invention, the entire shipment process for a user can be handled using email as the users have the ability to generate a shipment/pick-up request using email along with the ability to receive a commercial invoice via email.

In another exemplary embodiment, said shipping bill form comprises a hardcopy format, preferably a PDF format or an Excel format. In this case, an exemplary embodiment of the present invention provides a front-end which duplicates an existing hard copy way bill format. The user fills in details of the shipment in an electronic form, preferably in a PDF or Excel format, and sends it to the back-end service. The email handling system has a simple front-end displaying a PDF or Excel format, which a user needs to fill in and then click on the “Send to Shipper” button on the sheet itself. If a user is using Microsoft Outlook then the email handling system will automatically send it by means of the sender's MS Outlook and if the user is using any other email handling system like Lotus Notes then the user needs to save and attach the PDF or Excel file using his or her email client and send it across to the shipper.

In this scenario, the user does not select a format, a fixed form is provided either in PDF or Excel format and the email is sent to an email server, e.g. MS Exchange. A program converts the data on the fixed form into XML (Extensible Markup Language) and then performs necessary validations in order to make sure that it is indeed an authentic shipment/pick-up request. On receipt by back-end services, the data on the form is retrieved, i.e. extracted, validated against existing back-end validations and an appropriate reply is send to the user.

This is a simple but innovative solution that provides small and medium-sized users with the capability to transact with a shipper via email. This tool comprises a very light footprint to receive and send way bills, commercial invoices etc. via email. If the shipment is processed without any error then a shipping bill is generated and sent back to the user to take a print out and stick it on the shipment. As mentioned above, the data exchange is preferably carried out through XML format running on top of the Internet Protocol layer to access the back-end system of the shipper. The XML format may be either a standardized XML format, a commercially available but non-standardized XML format or even a customized XML format developed especially for the example embodiments of the invention.

In an exemplary embodiment of the invention, there is provided another step of retrieving the shipping information from said filled in shipping bill form and/or validating the shipping information against validation data provided in the back-end.

This step may be followed by a further step of sending an email message or an instant message to the user at the front-end, allowing the user to print out said filled in shipping bill form and stick it on the shipment to be shipped if the shipping information has passed a validation.

Typically, a shipping order is complete when the user has obtained the proper shipping bill. The shipping bill typically contains multiple items of information, such as source and destination addresses, weight and any other information.

In case the shipping information has not passed a validation, there may be provided a further step of sending an email message or an instant message to the user at the front-end incorporating an error message and eventually proposing correcting measures.

Subsequently, if there is an error, then the user is notified to take appropriate corrective measures in order to get the shipment processed successfully. Another exemplary embodiment provides an offer of a pick-up service for the shipment to be shipped to a user at the front-end.

An exemplary embodiment of the present invention may also allow the users to arrange for a courier pick-up by providing details of the pick-up location and the time their packages are ready.

A computer system for facilitating shipping according to an exemplary embodiment of the present invention comprises:
means for providing a shipping bill form at a front-end of a computer system; and
means for enabling a user at the front-end to fill in shipping information associated with said shipping bill form and to send an email message or an instant message incorporating said filled in shipping bill form to a back-end of said computer system.

A communication module comprised by the computer system may comprise tools that allow the system to communicate with multiple devices using multiple message formats, e.g. voice mail, text message, etc., that are streamed through multiple communication methods. For example, the system may automatically generate a voice message that is communicated to a courier by telephone, in which case the system utilizes the tools of the communication module to communicate with the courier.

The exemplary computer system may further comprise means for automatically sending an email draft message or an instant draft message to a user.

In another exemplary embodiment, the computer system comprises means for retrieving shipping information from said filled in shipping bill form and/or validating shipping information from said filled in shipping bill form.

An exemplary embodiment of the present invention described herein is set forth in terms of methods and computer systems implementing those methods. It will be apparent, however, to one with ordinary skill in the art that an exemplary embodiment of the present invention may be implemented as computer software, e.g. computer program code, capable of being stored in a computer memory and executed by a microprocessor.

Each component or module of the computer system may be implemented as part of a larger infrastructure, e.g. within an application server, or as one or more plug-in programs, applets, dynamically loaded libraries, or any other configuration that allows programs to run on one or more computers in order to provide shipping information management. The programs may be embedded within, or interfaced with third party applications. Although described in modular terms for purposes of illustration, embodiments of the invention need not be limited to modular implementations. The functionality described herein may be implemented in software and/or hardware as a single process or as a combination of multiple processes and/or applications.

Additional components of the exemplary computer system may reside in a server that users are able to access remotely using, for example, web browser software such as Internet Explorer or Netscape Navigator. Exemplary embodiments of such computer systems may also include a client application that executes on the user's computer. The client application may execute as a separate process, or as a helper application that extends a web browser's capabilities and enables the latter to communicate with the computer system. The client application may collect certain data related to shipping transactions from the user's computer, and detect such transactions when the user fills in a shipping bill form.

The user may register with the computer system to provide information such as the users address, user billing information, e.g. credit card information, and user shipping preferences. Subsequent to registration, the user may access the system using authentication methods, e.g. user identification and password parameters.

One or more exemplary embodiments of the invention may work with and/or in support of third party shipping and mailing software tools. For example, the client application may be automatically activated when the user prints a shipping bill form. As part of the shipping bill form printing process, the user provides transaction-specific information about the shipment, such as the selected class of shipping, the destination address, the weight and/or size of the package(s), etc. Further, transaction-specific information, e.g. value, corrected address, etc. may be derived by the back-end of the computer system based on the users information.

While example embodiments are described herein, the various aspects of the present invention may be used with various types of computer systems, generally including all system designs which link together disparate processing units such as computers, servers, peripherals, storage devices, and devices for data communications. Examples of such computer systems may include a local area network (LAN), a wide area network (WAN), a metropolitan area network (MAN), and a global area network (GAN).

Example embodiments may relate to an Internet/XML solution, although the scope of an exemplary embodiment of the present present invention is not limited thereto. A wide variety of implementations, arrangements and configurations of terminals, switches and links in all types of data networks may be utilized.

The computer system according to an exemplary embodiment of the present invention may include a plurality of component modules. These software component modules may be either commercially available off-the-shelf software, customized software or independently developed software. For example, freight rate databases are commercially available. If they are robust and capable of integration with other software components to accomplish the workflows described below, then they can be utilized in an exemplary computer system.

The exemplary computer system may be centralized in one or relatively few locations or may be distributed throughout a relatively large number of locations. As will be made clear below, each physical shipment may represent a plurality of different related work process flows, such as a shipment offer, a shipment acceptance, a customs clearance, in the system. Furthermore, the duty to be paid for a shipment may be calculated in various phases of the plurality of different related work process flows.

Other features of exemplary embodiments of the present invention may be apparent to those skilled in the art from the detailed description of the example embodiments and claims when read in connection with the accompanying drawings. While the foregoing and following written and illustrated disclosure relates to example embodiments of the invention, it should be understood that the same is by way of illustration and example only, is not to be taken by way of limitation and may be modified in learned practice of the invention. While the foregoing has described what are considered to be example embodiments of the invention, it is understood that various modifications may be made therein and that the invention may be implemented in various forms. The invention is defined by the claims and their full scope of equivalents.

### REFERENCE LIST

DCS dynamic channel selection
AWB air way bill
GAS generic application server
XLS data format type
MQ message queue
XSD data format type
Poc.ini error code
ESDDB database
IBSDB database
IBS intelligent business system
PSDDB database
SCL structured control language
A/c Account holder
CSM user service management
CIS user information system
Bkg Booking
KUL-APIS Kuala Lumpur International Airport—advance passenger information system
ESD electronic software distribution

1. A method for facilitating shipping, comprising:
providing a shipping bill form at a front-end of a computer system; and
enabling a user at the front-end to fill in shipping information associated with the shipping bill form and to send an email message or an instant message incorporating the filled in shipping bill form to a back-end of the computer system.

2. The method according to claim 1, comprising automatically sending an email draft message or an instant draft message, incorporating the filled in shipping bill form to be sent by the user.

3. The method according to claim 1, wherein the shipping bill form comprises a way bill form, an air way bill form, a sea way bill form or an express way bill form.

4. The method according to claim 1, wherein the shipping bill form comprises an invoice.

5. The method according to claim 1, wherein the shipping bill form comprises a hardcopy format, a PDF format or an Excel format.

6. The method according to claim 1, comprising retrieving the shipping information from the filled in shipping bill form and/or validating the shipping information against validation data provided in the back-end.

7. The method according to claim 6, comprising sending an email message or an instant message to the user at the front-end allowing the user to print out the filled in shipping bill form and stick it on the shipment to be shipped if the shipping information has passed a validation.

8. The method according to claim 6, comprising sending an email message or an instant message to the user at the front-end incorporating an error message and eventually proposing correcting measures if the shipping information has not passed a validation.

9. The method according to claim 1, comprising offering a pick-up service for the shipment to be shipped to a user at the front-end.

10. A system for facilitating shipping, comprising:
means for providing a shipping bill form at a front-end of a computer system; and
means for enabling a user at the front-end to fill in shipping information associated with the shipping bill form and to send an email message or an instant message incorporating the filled in shipping bill form to a back-end of the computer system.

11. The system according to claim 10, comprising means for automatically sending an email draft message or an instant draft message.

12. The system according to claim 10, comprising means for retrieving shipping information from the filled in shipping bill form and/or validating shipping information from the filled in shipping bill form.

13. A system for facilitating shipping, comprising:
a shipping bill form provider at a front-end of a computer system; and
a user enabler at the front-end that is adapted to fill in shipping information associated with the shipping bill form and to send an email message or an instant message incorporating the filled in shipping bill form to a back-end of the computer system.

14. The system according to claim 13, comprising an email sender that is adapted to send an email draft message or an instant draft message.

15. The system according to claim 13, comprising a retriever that is adapted to retrieve shipping information from the filled in shipping bill form and/or validating shipping information from the filled in shipping bill form.
